(19) United States
(12) Patent Application Publication
(10) Pub. No.: US 2019/0111854 A1
(43) Pub. Date: Apr. 18, 2019

(54) Tailgate Storage Box

(71) Applicant: Harold Abel-Bey, San Antonio, TX (US)

(72) Inventor: Harold Abel-Bey, San Antonio, TX (US)

(21) Appl. No.: 16/161,202

(22) Filed: Oct. 16, 2018

Related U.S. Application Data
(60) Provisional application No. 62/573,396, filed on Oct. 17, 2017.

(51) Int. Cl. B60R 9/06; B60R 11/02; B60Q 3/30; B60R 16/03; B60Q 1/26; B60R 7/02; E05F 15/53

(52) U.S. Cl. CPC B60R 9/065; B60R 11/0235; B60Q 3/30; E05Y 2900/53; B60Q 1/2661; B60R 7/02; E05F 15/53; B60R 16/03

(57) ABSTRACT

A tailgate storage box for entertainment while in the bed of a pickup truck. The device includes a housing having an interior volume formed by a pair of opposing sidewalls, a front wall, and a rear wall. The interior volume of the housing is accessed through an open top end. A lid is disposed over the open top end, wherein the lid is pivotally affixed to the housing. A control, such as a remote control, moves the lid between a closed and open position when actuated. A media display device is suspended from an interior surface of the lid, wherein the media display device can be watched when the lid is in the open position and wherein the media display device is housed in the housing when in the lid is in the closed position.

### CROSS REFERENCE TO RELATED APPLICATIONS

This application claims the benefit of U.S. Provisional Application No. 62/573,396 filed on Oct. 17, 2017. The above identified patent application is herein incorporated by reference in its entirety to provide continuity of disclosure.

### BACKGROUND OF THE INVENTION

The present invention relates to storage boxes. Specifically, the present invention relates to storage boxes for tailgating supplies and entertainment devices. Further, the present invention relates to those storage boxes that secure onto the bed of a pickup truck.

Tailgating is a popular way to celebrate team spirit prior to a game or match. Typically, tailgating involves enjoying beverages, barbequing, listening to music, and perhaps even watching other sporting events. Tailgating often occurs at the rear end of a vehicle, i.e. at the tailgate, where all the party supplies can be easily accessed in the truck or pickup truck bed. Accordingly, a storage box that is adapted to be installed in the bed of a pickup truck and offers the amenities brought to a tailgate party is desirable.

Several storage boxes have been proposed to aid in the transportation and organization of tailgating supplies. One such device provides a cabinet which includes a refrigerator, a grill and a draft system, wherein the cabinet is coupled to a hitch assembly. Another device provides a storage box for tailgating supplies, wherein the storage box is secured to the bed of a pickup truck. However, these devices do not provide tailgating storage box adapted to be secured to a pickup truck bed and a fold down media display device affixed to a remote controllable lid.

### SUMMARY OF THE INVENTION

In view of the foregoing disadvantages inherent in the known types of storage boxes now present in the prior art, the present invention provides a box wherein the same can be utilized for providing convenience for the user when tailgating. The present storage box comprises a housing having an open top end, a pair of opposing sidewalls, a front wall, and a rear wall defining an interior volume. The interior volume of the housing is accessed through the open top end. A lid is pivotally affixed to the rear wall, wherein the lid covers the open top end in a closed position and leaves the open top end ajar when in an open position. The lid is operably connected to a controller that is configured to control the position of the lid. A media display device is pivotally suspended from an interior surface of the lid. In some embodiments, speakers are disposed in the sidewalls of the housing.

One object of the present invention is to provide a storage box having a media display device affixed to an interior surface of a lid, wherein the media display device is housed in the storage box when the lid is in the closed position and can be viewed by a user when the lid is in an open position.

Another object of the present invention is to provide a storage box having a deployable media display device, wherein the storage box is adapted to be secured to a bed of a pickup truck.

A further object of the present invention is to provide a storage box having a speaker disposed in the sidewall thereof.

Yet another object of the present invention is to provided a storage box for a tailgate event, wherein the storage box has a media device affixed to a lid and the lid can be raised and lowered by a control, such as a remote control.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tailgate storage box.

FIG. 2A shows a perspective view of an embodiment of the tailgate storage box in an open position secured to a bed of a truck.

FIG. 2B shows a perspective view of an embodiment of the tailgate storage box in a closed position secured to a bed of a truck.

FIG. 3 shows a close up view the media display device of an embodiment of the tailgate storage box.

FIG. 4 shows an alternate perspective view of an embodiment of the tailgate storage box.

### DETAILED DESCRIPTION OF THE INVENTION

Reference is made herein to the attached drawings. Like reference numerals are used throughout the drawings to depict like or similar elements of the tailgate storage box. The figures are intended for representative purposes only and should not be considered to be limiting in any respect. Unless specifically limited to a single unit, “a” is intended to be equivalent to “one or more” throughout the present disclosure.

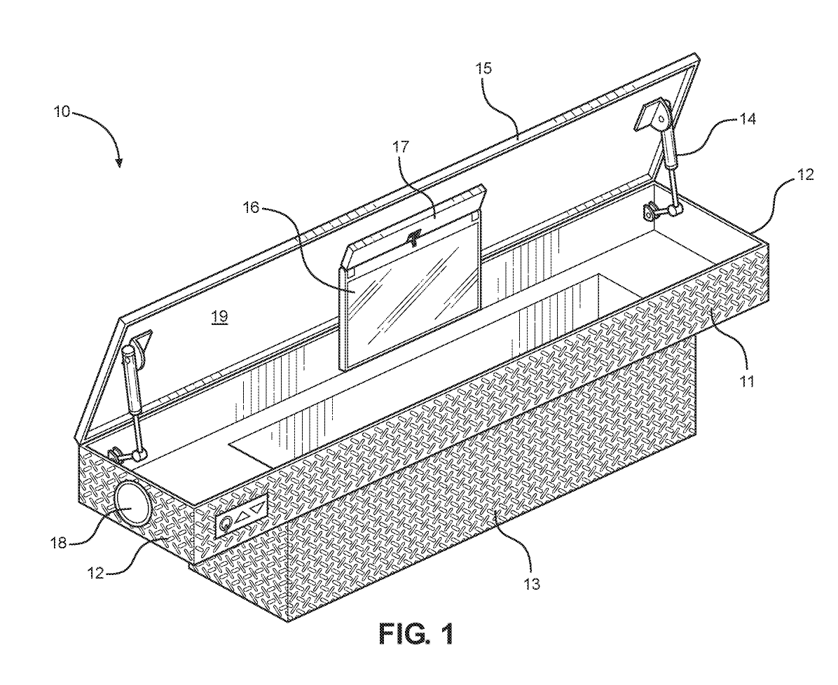

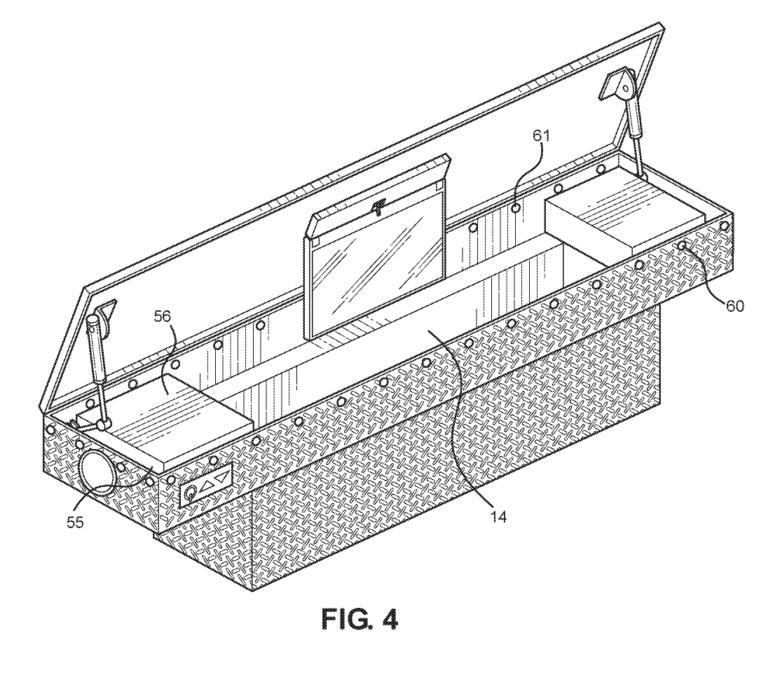

Referring now to FIG. 1, there is shown a perspective view of an embodiment of the tailgate storage box. The tailgate storage box 10 comprises a housing 11 having an interior volume 14 defined by a front wall 13, a rear wall, a pair of opposing sidewalls 12 and an open top end. A lid 15 is pivotally affixed to the rear wall, e.g. by a hinge. A media display device 16, e.g. a television, is affixed to an interior surface 19 of the lid 15. The interior surface 19 is the surface that faces the interior volume 14 of the housing when the lid 15 is in a closed position. In the shown embodiment, the media display device 16 is pivotally affixed to the interior surface 19 of the lid 15 by a support 17. The media display device 16 pivotally connected to a lateral side of the support 17, wherein the support 17 is directly mounted to the interior surface 19. As seen in FIG. 4, a hinge member 41 is secured to the media display device 16, through an aperture 40 on the support member 17. In this way, the media display device 16 is allowed to freely pivot when suspended from the lid 15.

In the illustrated embodiment, a speaker is disposed in at least one of the sidewalls 12 of the housing, wherein the speaker 18 directs sound away from the housing 11. In the present embodiment, a speaker 18 is disposed within each sidewall 12. In the illustrated embodiment, the outer most surface of the speaker is flush with the exterior surface of the sidewall. The media display device 16 and the speaker 18 are operably connected to a power source. In the illustrated embodiment, the power source is the battery within an engine of an automobile to which the tailgate storage box 10 is sequestered.

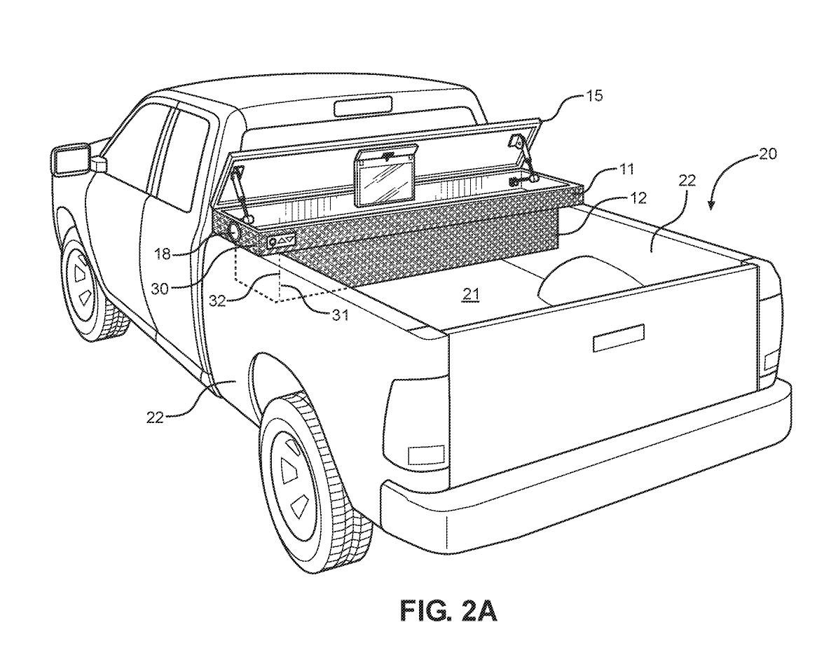

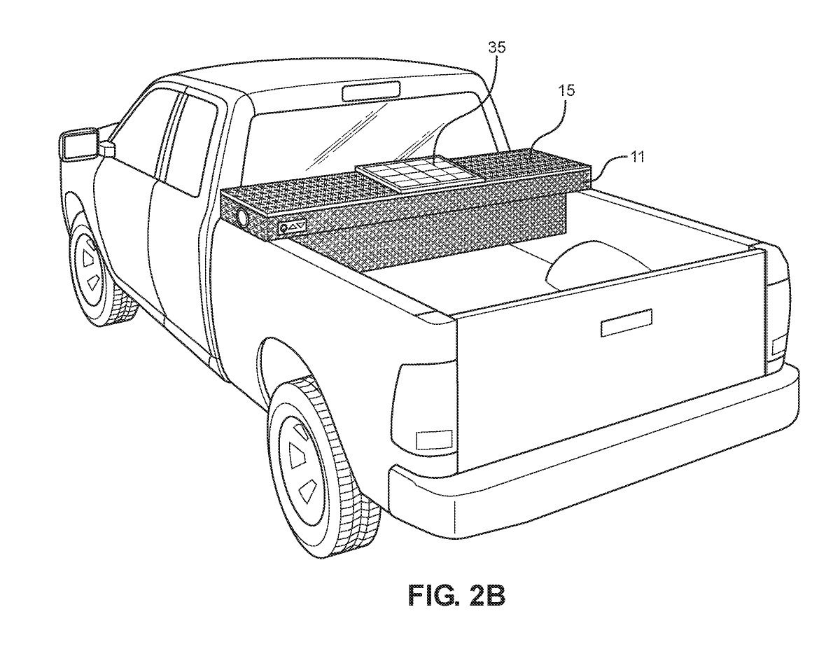

Referring now to FIG. 2A, there is shown a perspective view of an embodiment of the tailgate storage box 10 in an open position secured to a bed 20 of a truck. The tailgate storage box 10 is configured to be secured within a bed 20 of a pickup truck. In one embodiment, the sidewalls 12 of the housing 11 have an in-cut portion 31, wherein the in-cut portion 31 is a lower portion of the sidewall 12. The in-cut portion 31 is cut inward at a right angle, thereby forming a horizontal overhanging ledge 30. The horizontal overhanging ledge 30 rests atop a pickup bed sidewall 22. The length of each in-cut portion 31, i.e. the length between the horizontal overhanging ledge 30 and a bottom end of the housing 21, is the width of the pickup bed sidewall 22. This configuration results in the storage box 10 having a top section with a larger volume than that of a bottom section. In the illustrated embodiment, the speaker 18 is disposed in the sidewall 12 above the in-cut portion 31.

Now referring to FIG. 2B, there is shown a perspective view of an embodiment of the tailgate storage box in a closed position secured to a bed of a truck. In the illustrated embodiment, a solar panel 35 provides is the power source that is operably connected to the media display device and speaker. In the illustrated embodiment, the solar panel 35 is disposed centrally on an exterior surface of the lid 15.

The lid 15 of the housing 11 selectively moves between an open position, as shown in FIG. 2A, and a closed position, as shown in FIG. 2B. When the lid 15 is in the open position, the interior volume is accessible to a user. When the lid 15 is in the closed position, the open top end is completely covered by the lid 15, thereby preventing a access to the interior volume by a user.

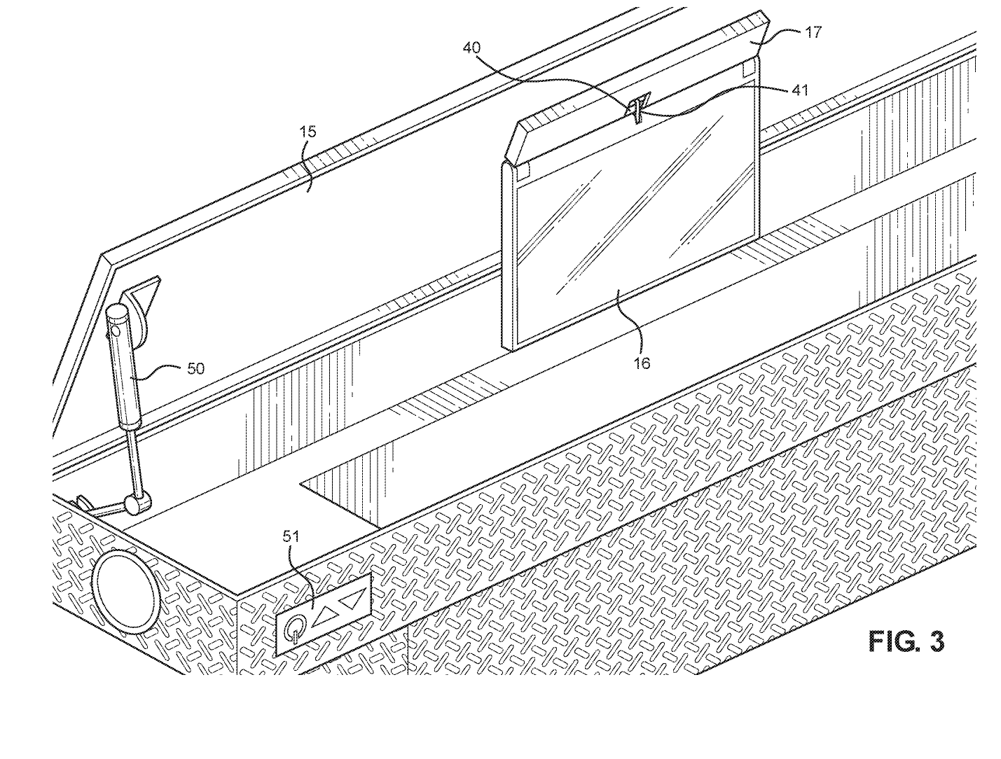

Now referring to FIG. 3, there is shown a close up view the media display device of an embodiment of the tailgate storage box. In the present embodiment, the tailgate storage box further comprises a pair of arm members 50. Each arm member 50 is coupled to the lid 15 on one end of the arm member 50 and to the housing 11, specifically the sidewall 12, on the other end. At least one of these couplings, is a pivot style coupling.

In the illustrated embodiment, the arm members 50 are operably connected to a control 51. In the illustrated embodiment, the control 51 is directly disposed on the housing. However, in alternate embodiments, the control is a remote control. Actuation of the control 51 either raises the lid 15 to the open position or lowers the lid to the closed position. Triggers for both raising and lowering the lid 15 are provided on the control 51. When the control 51 is actuated, opposing forces are exerted upon the housing 11 and the lid 15 through the arm members 50, thereby selectively moving the lid 15 between the closed position and open position. In the present embodiment, the arm members 50 are hydraulic scissor arm members.

Now referring to FIG. 4, there is shown an alternate perspective view of an embodiment of the tailgate storage box. In alternate embodiments, the housing 11 has insulated walls 55, thereby providing a temperature mediated interior volume. In the shown embodiment, the interior volume is divided into insulated compartments 56 and non-insulated compartments 14. Further, as shown in FIG. 4, an interior light 61 is disposed in or on the housing 11, wherein the interior light 61 illuminates the interior volume of the housing 11. In the shown embodiment, an exterior light 60 is also disposed on the housing, wherein the exterior light 60 projects light away from the housing. In the shown embodiment, a plurality of exterior lights 60 is disposed on the front wall 13 and sidewalls 12 of the housing 11. The interior and exterior lights 60 and 61 are operably connected to the power source and, in certain embodiments, to the controller 51.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tailgate storage box, comprising:
a housing having a pair of opposing sidewalls, a front wall, and a rear wall defining an interior volume, and an open top end;
wherein the housing is configured to secure to a bed of a truck;
a lid pivotally affixed to the housing, wherein the lid is disposed over the open top end and selectively moves between a closed position, wherein the lid covers the open top end, and an open position, wherein the interior volume is accessible;
a media display device affixed to an interior surface of the lid, wherein the media display device is contained within the interior volume of the housing when the lid is in the closed position.

2) The tailgate storage box of claim 1, further comprising a pair of arm members operably connected to a control, wherein each arm member of the pair of arm members is coupled to the lid and the housing, wherein an actuation of the control exerts a force upon the lid and the housing through the pair of arm members, thereby selectively moving the lid between the open position and closed position.

3) The tailgate storage box of claim 2, wherein the pair of arm members is a pair of hydraulic arm members.

4) The tailgate storage box of claim 2, wherein the control is a remote control.

5) The tailgate storage box of claim 2, wherein the control is directly affixed to the housing.

6) The tailgate storage box of claim 1, wherein a speaker is disposed in a sidewall of the pair of opposing sidewalls of the housing.

7) The tailgate storage box of claim 1, wherein each sidewall of the pair of opposing sidewalls has an in-cut portion configured to rest flush against a pair of opposing sidewalls defining the bed of a truck.

8) The tailgate storage box of claim 7, wherein the in-cut portion is disposed inward at a right angle relative to an upper portion of the pair of opposing sidewalls, wherein the upper portion forms a horizontal overhanging ledge.

9) The tailgate storage box of claim 1, wherein the housing is insulated.

10) The tailgate storage box of claim 1, wherein a plurality of lights is disposed on the housing.

11) The tailgate storage box of claim 1, wherein a light is disposed on the housing, wherein the light illuminates the interior volume of the housing.

12) The tailgate storage box of claim 1, wherein a solar panel disposed on the lid is electrically connected to a battery, wherein the media display device is electrically connected to the battery.
